(19) United States
(12) Patent Application Publication
(10) Pub. No.: US 2017/0269519 A1
(43) Pub. Date: Sep. 21, 2017

(54) FIXING DEVICE, IMAGE FORMING APPARATUS, AND FIXING METHOD

(71) Applicant: FUJI XEROX CO., LTD., Tokyo (JP)

(72) Inventors: Hiroki YAMAZAKI, Kanagawa (JP); Yasutaka NAITO, Kanagawa (JP); Eiichiro TOKUHIRO, Kanagawa (JP); Tsuyoshi SUNOHARA, Kanagawa (JP)

(73) Assignee: FUJI XEROX CO., LTD., Tokyo (JP)

(21) Appl. No.: 15/253,087

(22) Filed: Aug. 31, 2016

(30) Foreign Application Priority Data
Mar. 18, 2016 (JP) 2016-054889

(51) Int. Cl. G03G 15/20

(52) U.S. Cl. CPC G03G 15/2039

(57) ABSTRACT

A fixing device includes a pair of fixing members disposed to face each other in a fixing area, a movable member movably supporting at least one of the fixing members between first and second positions, a driving device including a contact member and a drive source to move the movable member between the first and second positions, and a controller that controls the driving device, and if a temperature of the one of the fixing members is equal to or higher than a preset temperature when the driving device moves the movable member from the second position to the first position, changes the control to make driving force constantly exceed a rotational load of the driving device in accordance with advancement of a time of increase in the rotational load as compared with when the temperature of the one of the fixing members is lower than the preset temperature.

### CROSS-REFERENCE TO RELATED APPLICATIONS

This application is based on and claims priority under 35 USC 119 from Japanese Patent Application No. 2016-054889 filed Mar. 18, 2016.

### BACKGROUND

The present invention relates to a fixing device, an image forming apparatus, and a fixing method.

### SUMMARY

According to an aspect of the invention, there is provided a fixing device including a pair of fixing members, a movable member, a driving device, and a controller. The pair of fixing members are disposed to face each other in a fixing area in which an unfixed image is fixed. The movable member movably supports at least one of the fixing members between a first position at which one of the fixing members and an other one of the fixing members come into contact with each other with preset fixing pressure and a second position at which the one of the fixing members and the other one of the fixing members are relatively moved in a direction of separating farther from each other than at the first position. The driving device includes a contact member and a drive source, and moves the movable member between the first position and the second position. The contact member is supported to be rotatable around a rotation center, and contacts the movable member. The drive source drives the contact member. The controller controls the driving device, and if a temperature of the one of the fixing members is equal to or higher than a preset temperature when the driving device moves the movable member from the second position to the first position, changes the control of the driving device to make driving force constantly exceed a rotational load of the driving device in accordance with advancement of a time of increase in the rotational load as compared with when the temperature of the one of the fixing members is lower than the preset temperature.

### BRIEF DESCRIPTION OF THE DRAWINGS

Exemplary embodiments of the present invention will be described in detail based on the following figures, wherein:

FIG. 1 is an overall view illustrating an image forming apparatus of a first embodiment example of the invention;

FIG. 2 is an enlarged view illustrating major parts of a fixing device of the first embodiment example;

FIGS. 3A and 3B are diagrams illustrating a configuration that causes fixing members to contact and separate from each other, FIG. 3A being a diagram illustrating a state in which the fixing members are in contact with each other, and FIG. 3B being a diagram illustrating a state in which the fixing members are separated from each other;

FIGS. 4A and 4B are diagrams illustrating a contact member of the first embodiment example, FIG. 4A being a front view, and FIG. 4B being a graph illustrating the radius and the phase of the outer circumferential surface of the contact member;

FIGS. 5A to 5C illustrate the shape of the contact member, fixing pressure, and load torque on a drive source at low temperature, FIG. 5A being a graph with the horizontal axis representing the rotational position and the vertical axis representing the radius, FIG. 5B being a graph with the horizontal axis representing the rotational position and the vertical axis representing the load, and FIG. 5C being a graph with the horizontal axis representing the rotational position and the vertical axis representing the torque;

FIGS. 6A to 6C illustrate the shape of the contact member, the fixing pressure, and the load torque on the drive source at high temperature, FIG. 6A being a graph with the horizontal axis representing the rotational position and the vertical axis representing the radius, FIG. 6B being a graph with the horizontal axis representing the rotational position and the vertical axis representing the load, and FIG. 6C being a graph with the horizontal axis representing the rotational position and the vertical axis representing the torque;

FIG. 7 is a diagram illustrating a fixing device of a second embodiment example of the invention and corresponding to FIG. 3A of the first embodiment example; and

FIGS. 8A and 8B are diagrams illustrating an input signal of the second embodiment example, FIG. 8A being a diagram illustrating the input signal at low temperature and FIG. 8B being a diagram illustrating the input signal at high temperature.

### DETAILED DESCRIPTION

Specific examples of an exemplary embodiment of the present invention (hereinafter described as embodiment examples) will now be described with reference to the drawings. The invention, however, is not limited to the following embodiment examples.

In the drawings, the depth direction, the horizontal direction, and the vertical direction will be referred to as the X-axis direction, the Y-axis direction, and the Z-axis direction, respectively, and the directions or sides indicated by arrows X, −X, Y, −Y, Z, and -Z will be referred to as the front, rear, right, left, upper, and lower directions or sides, respectively, for easier understanding of the following description.

Further, a circle with a dot therein represents an arrow pointing from the back to the front of the paper, and a circle with an “x” therein represents an arrow pointing from the front to the back of the paper.

In the following description using the drawings, illustration of members other than those required for the description will be omitted as appropriate for easier understanding.

### First Embodiment Example

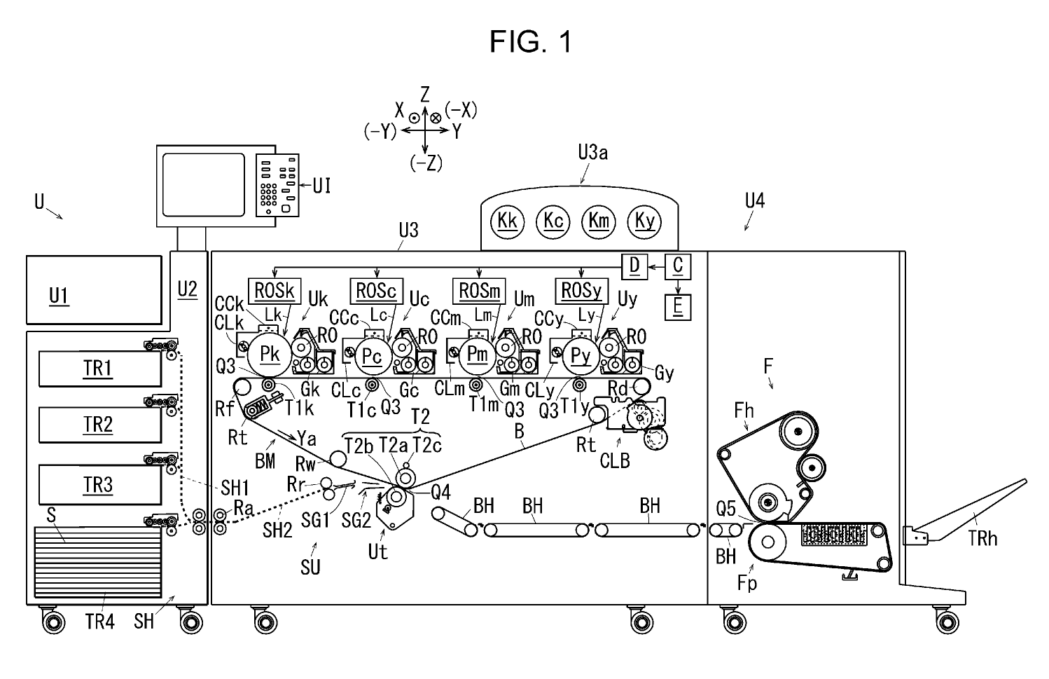

FIG. 1 is an overall view illustrating an image forming apparatus of a first embodiment example of the invention.

In FIG. 1, an image forming apparatus U includes an operating unit UI, a scanner device U1 as an example of an image reading unit, a sheet feed device U2, an image forming apparatus body U3, and a sheet exit unit U4.

The operating unit UI includes a power button, a copy start key, a copy count setting key, and numeric keys as examples of an input unit, a display, and so forth.

The scanner device UI reads a not-illustrated document, converts the read information into image information, and inputs the converted image information to the image forming apparatus body U3.

The sheet feed device U2 includes plural sheet feed trays TR1 to TR4 as examples of a sheet feed unit. Each of the sheet feed trays TR1 to TR4 stores a recording sheet S as an example of a medium. A sheet feed path SH1 as an example of a transport path for the medium extends from each of the sheet feed trays TR1 to TR4 to the image forming apparatus body U3.

In FIG. 1, the image forming apparatus body U3 includes a controller C, a power supply circuit E that supplies power to respective members of the image forming apparatus body U3 under control by the controller C, and so forth. The image information of the document read by the scanner device U1 or image information transmitted from a personal computer as an example of a not-illustrated information transmitting apparatus connected to the image forming apparatus U is transmitted to the controller C.

The controller C processes the received image information into information for printing in yellow (Y), magenta (M), cyan (C), and black (K), and outputs the processed information to a laser driving circuit D as an example of a driving circuit of a latent image writing device. At a preset time, the laser driving circuit D outputs a laser driving signal input from the controller C to each of latent image forming devices ROSy, ROSm, ROSc, and ROSk for the respective colors.

Image carrier units Uy, Um, Uc, and Uk for Y, M, C, and K are disposed below the respective latent image forming devices ROSy to ROSk.

In FIG. 1, the image carrier unit Uk for black (K) includes a photoconductor drum Pk as an example of an image carrier, a corotron CCk as an example of a charger, and a photoconductor cleaner CLk as an example of a cleaner for the image carrier. Further, the image carrier units Uy, Um, and Uc for the other colors Y, M, and C also include photoconductor drums Py, Pm, and Pc, corotrons CCy, CCm, and CCc, and photoconductor cleaners CLy, CLm, and CLc, respectively.

In the first embodiment example, the photoconductor drum Pk for the color K, which is frequently used and a surface of which abrades much, is configured to be greater in diameter than the photoconductor drums Py, Pm, and Pc for the other colors to realize high-speed rotation and extension in lifetime.

The photoconductor drums Py, Pm, Pc, and Pk are uniformly charged by the corotrons CCy, CCm, CCc, and CCk, respectively. Thereafter, electrostatic latent images are formed on respective surfaces of the photoconductor drums Py to Pk with laser beams Ly, Lm, Lc, and Lk as examples of latent image writing light output by the latent image forming devices ROSy, ROSm, ROSc, and ROSk. The electrostatic latent images on the surfaces of the photoconductor drums Py, Pm, Pc, and Pk are developed into toner images as examples of a visible image by developing rollers R0 as examples of a developing member provided in developing devices Gy, Gm, Gc, and Gk with developers of the respective colors yellow (Y), magenta (M), cyan (C), and black (K).

The toner images on the surfaces of the photoconductor drums Py, Pm, Pc, and Pk are sequentially superimposed and transferred onto an intermediate transfer belt B, which is an example of an intermediate transfer body and an example of an image carrier, in first transfer areas Q3 with first transfer rollers T1y, T1m, T1c, and T1k as examples of a first transfer unit. Thereby, a multicolor image, that is, a so-called color image is formed on the intermediate transfer belt B. The color image formed on the intermediate transfer belt B is transported to a second transfer area Q4.

If the image data only includes black image data, only the photoconductor drum Pk and the developing device Gk for black are used to form only a back toner image.

After the first transfer, residual toner remaining on the surfaces of the photoconductor drums Py, Pm, Pc, and Pk is cleaned off by photoconductor cleaners CLy, CLm, CLc, and CLk.

The image carrier units Uy, Um, Uc, and Uk and the developing devices Gy, Gm, Gc, and Gk as examples of a developing device form toner image forming members Uy+Gy, Um+Gm, Uc+Gc, and Uk+Gk as examples of a visible image forming unit.

A toner dispenser U3a as an example of a supplying device is disposed on an upper part of the image forming apparatus body U3. Toner cartridges Ky, Km, Kc, and Kk as examples of a container for storing the developer are attachably and detachably installed in the toner dispenser U3a. If toner is consumed in any one of the developing devices Gy to Gk with image formation, toner is supplied from the corresponding one of the toner cartridges Ky to Kk to the one of the developing devices Gy to Gk.

The intermediate transfer belt B disposed under the photoconductor drums Py to Pk is stretched with tension by an intermediate drive roller Rd as an example of a drive member of the intermediate transfer body, intermediate tension rollers Rt as examples of a tension providing member that provides tension to the intermediate transfer belt B, an intermediate steering roller Rw as an example of a first deviation correcting member that corrects deviation and meandering of the intermediate transfer belt B, plural intermediate idler rollers Rf as examples of a driven member of the intermediate transfer body, and a backup roller T2a as an example of a facing member in the second transfer area Q4. Further, the intermediate transfer belt B is supported to be rotationally movable in the direction of arrow Ya by the drive of the intermediate drive roller Rd.

The intermediate drive roller Rd, the intermediate tension rollers Rt, the intermediate steering roller Rw, the intermediate idler rollers Rf, and the backup roller T2a form belt supporting rollers Rd+Rt+Rw+Rf+T2a as examples of a supporting member of the intermediate transfer body of the first embodiment example. Further, the intermediate transfer belt B, the belt supporting rollers Rd+Rt+Rw+Rf+T2a, and the first transfer rollers T1y to T1k form a belt module BM as an example of an intermediate transfer device. The belt module BM of the first embodiment example is formed of a unit attachable to and detachable from the image forming apparatus body U3 to be replaceable.

The intermediate steering roller Rw of the first embodiment example is formed of a rotary body having a rotary shaft, and prevents the deviation and meandering of the intermediate transfer belt B with the rotary shaft slanted in a direction of correcting the deviation in accordance with the deviation in the width direction of the intermediate transfer belt B.

A second transfer unit Ut as an example of a transfer and transport device is disposed under the backup roller T2a. The second transfer unit Ut includes a second transfer roller T2b as an example of a transfer member. The second transfer roller T2b is disposed to face the backup roller T2a. An area in which the second transfer roller T2b faces the intermediate transfer belt B forms the second transfer area Q4. Further, the backup roller T2a is in contact with a contact roller T2c as an example of a contact member for voltage application. The rollers T2a to T2c form a second transfer unit T2.

A second transfer voltage having the same polarity as a toner charging polarity is applied to the contact roller T2c at a preset time by the power supply circuit E controlled by the controller C.

A sheet transport path SH2 is disposed below the belt module BM. The recording sheet S fed from the sheet feed path SH1 of the sheet feed device U2 is transported to the sheet transport path SH2 by transport rollers Ra, sent out by registration rollers Rr as examples of a sending-out member in accordance with the time at which the toner image is transported to the second transfer area Q4, and transported to the second transfer area Q4 while being guided by sheet guides SG1 and SG2 as examples of a medium guiding member.

The toner image on the intermediate transfer belt B is transferred onto the recording sheet S by the second transfer unit T2 when passing the second transfer area Q4. In the case of a color image, the toner images superimposed and first-transferred onto the surface of the intermediate transfer belt B are second-transferred in batch onto the recording sheet S.

After the second transfer, the intermediate transfer belt B is cleaned, that is, subjected to cleaning by a belt cleaner CLB as an example of a cleaner for the intermediate transfer body. The second transfer roller T2b is supported to be separable from and contactable with the intermediate transfer belt B.

The first transfer rollers T1y, T1m, T1c, and T1k, the intermediate transfer belt B, the second transfer unit T2, the belt cleaner CLB, and so forth form a transfer device T1+B+T2+CLB that transfers the images on the surfaces of the photoconductor drums Py to Pk onto the recording sheet S.

The recording sheet S having the toner image second-transferred thereto is sent to medium transport belts BH as examples of a transport member. The medium transport belts BH transport the recording sheet S to a fixing device F. The fixing device F includes a heating member Fh as an example of a heat fixing member and a pressure member Fp as an example of a pressure fixing member. An area in which the heating member Fh and the pressure member Fp come into contact with each other forms a fixing area Q5.

The toner image on the recording sheet S is heat-fixed by the fixing device F when passing the fixing area Q5. The recording sheet S having the toner image fixed thereon in the fixing device F is discharged to an exit tray TRh as an example of an exit unit.

The components indicated by the signs SH1 and SH2 and so forth form a sheet transport path SH. Further, the components indicated by the signs SH, Ra, Rr, SG1, SG2, BH and so forth form a sheet transport device SU.

### Description of Fixing Device

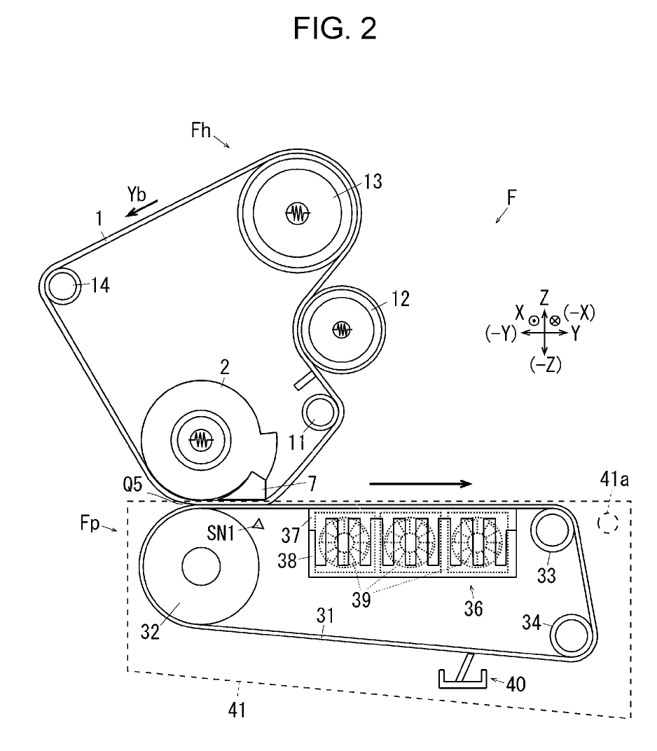

FIG. 2 is an enlarged view illustrating major parts of the fixing device F of the first embodiment example.

In FIGS. 1 and 2, the heating member Fh of the fixing device F in the first embodiment example includes a heating belt 1 as an example of a band-shaped body. The heating belt 1 of the first embodiment example is formed of an elastically deformable, endless band-shaped elastic member. A first heating roller 2 as an example of a drive member and an example of the body of a heating member is disposed on the inner circumference of the heating belt 1 at a position facing the sheet transport path SH. The first heating roller 2 of the first embodiment example includes therein a heater. The first embodiment example is configured to transmit drive from a not-illustrated drive source to the first heating roller 2.

A sliding pad 7 as an example of a band-shaped support member is supported on the right side of the first heating roller 2. The sliding pad 7 is formed into a substantially wedge shape. The sliding pad 7 is disposed to increase the area of contact between the recording sheet S and the heating belt 1.

A right support roller 11 as an example of a support member is disposed on the upper-right side of the first heating roller 2.

A second heating roller 12 as an example of the body of the heating member is disposed above the right support roller 11. The second heating roller 12 is disposed in contact with the outer surface of the heating belt 1. The second heating roller 12 of the first embodiment example includes therein a heater similarly to the first heating roller 2.

A third heating roller 13 as an example of the body of the heating member is disposed above the second heating roller 12. The third heating roller 13 is configured similarly to the second heating roller 12.

A left support roller 14 as an example of the support member is disposed on the lower-left side of the third heating roller 13.

In the first embodiment example, therefore, the heating belt 1 is stretched with tension by the first heating roller 2, the right support roller 11, the second heating roller 12, the third heating roller 13, and the left support roller 14. Further, with the rotation of the first heating roller 2, the heating belt 1 rotates in the direction of arrow Yb.

In FIGS. 1 and 2, the pressure member Fp as an example of a fixing member includes a pressure belt 31 as an example of an endless band-shaped rotary body.

A pressure roller 32 as an example of the body of a pressure member and an example of a support member is disposed on the inner circumference of the pressure belt 31 at a position facing the first heating roller 2 across the heating belt 1. In the first embodiment example, a temperature sensor SN1 as an example of a temperature detecting member is disposed in the vicinity of the pressure roller 32. The temperature sensor SN1 measures the temperature of the pressure roller 32.

An upper pressure support roller 33 as an example of the support member is disposed downstream of the pressure roller 32 in the transport direction of the recording sheet S. A lower pressure support roller 34 as an example of the support member is disposed below the upper pressure support roller 33.

The pressure belt 31 is therefore stretched with tension by the pressure roller 32 and the pressure support rollers 33 and 34. With the rotation of the first heating roller 2, the pressure belt 31 of the first embodiment example is driven to rotate via the heating belt 1.

A cooling device 36 as an example of a cooling member is disposed between the pressure roller 32 and the upper pressure support roller 33. The cooling device 36 of the first embodiment example includes a contact unit 37 that contacts the inner circumferential surface of the pressure belt 31. The contact unit 37 is formed with a heatsink 38 as an example of a heat radiating member. Cooling fans 39 as examples of a blowing member are supported at a rear end of the heatsink 38.

The first embodiment example is configured such that the cooling fans 39 blow cooling air to the heatsink 38 during the execution of a fixing operation to cool the recording sheet S via the pressure belt 31.

Further, a cleaner 40 as an example of a cleaner is disposed on the outer circumference of the pressure belt 31 on the left side of the lower pressure support roller 34. The cleaner 40 is configured to be able to remove developer, paper dust, and so forth adhering to the outer surface of the pressure belt 31.

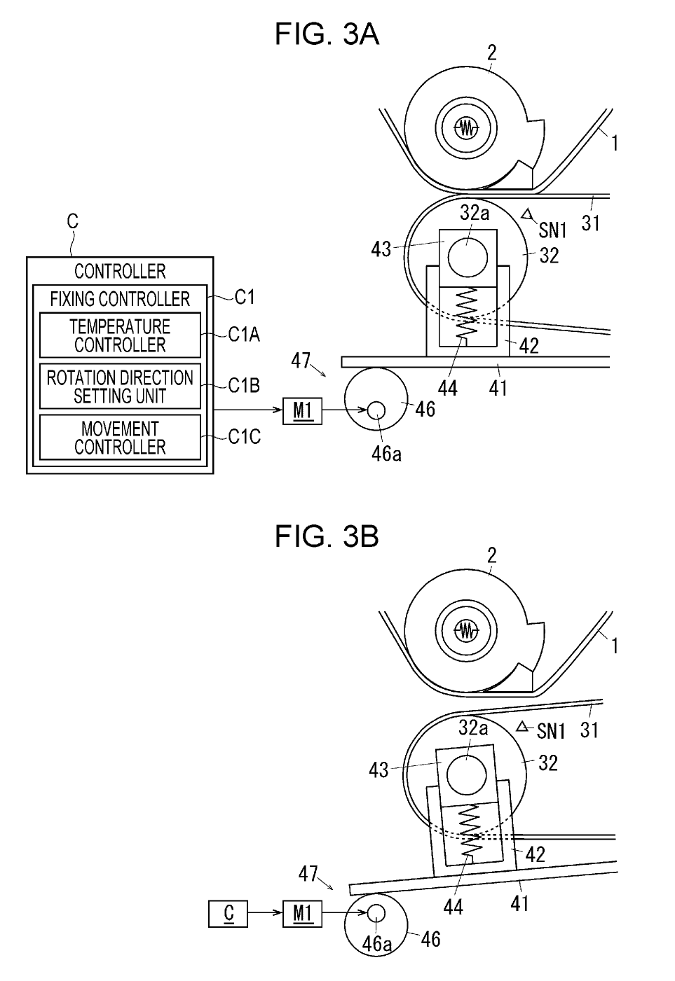

FIGS. 3A and 3B are diagrams illustrating a configuration that causes the fixing members to contact and separate from each other. FIG. 3A is a diagram illustrating a state in which the fixing members are in contact with each other. FIG. 3B is a diagram illustrating a state in which the fixing members are separated from each other.

In FIGS. 3A and 3B, the pressure member Fp as an example of one of the fixing members of the first embodiment example is supported by a rotary frame 41 as an example of a movable member. The rotary frame 41 is supported to be rotatable around a rotation center 41a at the right end in FIG. 2.

The rotary frame 41 supports shaft bearing guides 42 as examples of a guiding member. The shaft bearing guides 42 support shaft bearing members 43 to be movable in a direction of approaching and separating from the first heating roller 2. The shaft bearing members 43 rotatably support a shaft 32a of the pressure roller 32.

Springs 44 as examples of a biasing member are supported between the shaft bearing members 43 and the shaft bearing guides 42. The springs 44 press the pressure roller 32 toward the first heating roller 2 such that preset fixing pressure acts in the fixing area Q5 with the heating member Fh and the pressure member Fp in contact with each other.

A cam 46 as an example of a contact member is disposed under the left end of the rotary frame 41. The cam 46 is supported to be rotatable around a rotary shaft 46a.

The rotary shaft 46a receives drive transmitted from a motor M1 as an example of a driving device. A motor rotatable in the forward and reverse directions is used as the motor M1 of the first embodiment example. The cam 46, the motor M1, a not-illustrated gear train, and so forth form a driving device 47 of the first embodiment example.

The rotary frame 41 of the first embodiment example is therefore configured to be movable between a fixing position as an example of a first position illustrated in FIG. 3A and an idling position as an example of a second position illustrated in FIG. 3B with the driving of the motor M1. The rotary frame 41 of the first embodiment example is lifted to the fixing position by the cam 46, and is moved to the idling position by gravity and the resilience of the springs 44. Further, at the fixing position, the pressure belt 31 is pressed against the heating belt 1 with the elastic force of the springs 44 while in contact with the heating belt 1 with preset contact pressure. Further, at the idling position in the first embodiment example, the pressure belt 31 is separated from the heating belt 1.

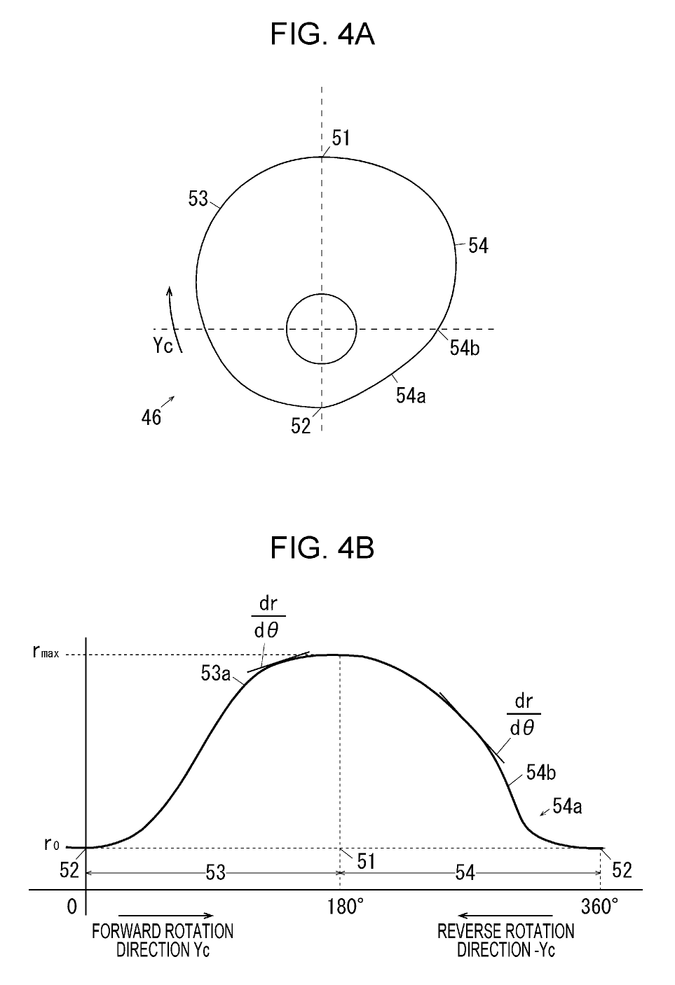

FIGS. 4A and 4B are diagrams illustrating the contact member of the first embodiment example. FIG. 4A is a front view, and FIG. 4B is a graph illustrating the radius and the phase of the outer circumferential surface of the contact member.

In FIGS. 3A and 3B and FIGS. 4A and 4B, the radius of the cam 46 of the first embodiment example is maximized at a first contact position 51 that comes into contact with the rotary frame 41 moved to the fixing position. Further, the radius of the cam 46 of the first embodiment example is minimized at a second contact position 52 that comes into contact with the rotary frame 41 moved to the idling position.

When the forward rotation direction of the cam 46 is represented as Yc in FIG. 4A, a surface from the second contact position 52 to the first contact position 51 along the forward rotation direction Yc forms a low-temperature contact surface 53 as an example of a first contact surface. Further, a surface from the first contact position 51 to the second contact position 52 along the forward rotation direction Yc forms a high-temperature contact surface 54 as an example of a second contact surface.

In FIG. 4B, when the phase of the second contact position 52 is represented as 0 degrees, the radius of the low-temperature contact surface 53 is increased toward the downstream side in the forward rotation direction Yc, as illustrated in FIG. 4B. Then, at a late phase position 53a close to the first contact position 51, the amount of change in radius is reduced. That is, the slope of the curve (profile) of the graph becomes less steep.

Meanwhile, the high-temperature contact surface 54 has a greater amount of change in radius than that of the low-temperature contact surface 53 at an initial phase position 54a in reverse rotation from the second contact position 52 toward the downstream side in a reverse rotation direction −Yc. That is, the outer circumferential surface of the cam 46 is formed such that the slope of the profile is steep at the initial phase position 54a, the amount of change in radius is smaller than on the low-temperature contact surface 53 at a middle phase position 54b in the reverse rotation, and the profile thereafter becomes less steep to the first contact position 51.

That is, in the cam 46 of the first embodiment example, the middle phase position 54b on the high-temperature contact surface 54, at which the amount of change in radius of the cam 46 is reduced along the reverse rotation direction −Yc, is set to be closer to the second contact position 52, that is, toward the low-angle side, than the late phase position 53a on the low-temperature contact surface 53, at which the amount of change in radius of the cam 46 is reduced along the forward rotation direction Yc.

In the fixing device F of the first embodiment example, the movement of the pressure belt 31 is controlled by a fixing controller C1 as an example of a controller in the controller C.

A temperature controller C1A of the fixing controller C1 controls a fixing temperature, which is the temperature of the surface of the heating belt 1 in the fixing area Q5, by controlling turn-on and turn-off of the respective heaters in the heating rollers 2, 12, and 13 based on the detection result of a not-illustrated temperature sensor for the heat fixing member.

A rotation direction setting unit C1B sets the rotation direction of the motor M1, that is, the rotation direction of the cam 46, based on the detection result of the temperature sensor SN1. If a detected temperature T1 of the temperature sensor SN is lower than a preset determination temperature Ta, the rotation direction setting unit C1B of the first embodiment example sets the rotation direction to the forward rotation direction Yc. If the detected temperature T1 of the temperature sensor SN is equal to or higher than the determination temperature Ta, the rotation direction setting unit C1B of the first embodiment example sets the rotation direction to the reverse rotation direction −Yc.

A movement controller C1C controls the movement of the pressure member Fp between the fixing position and the idling position by moving the rotary frame 41 via the cam 46. To perform the fixing operation, the movement controller C1C of the first embodiment example moves the pressure member Fp to the fixing position. Further, if the temperature of the heating belt 1 is lower than a preset temperature, the movement controller C1C of the first embodiment example moves the pressure member Fp to the idling position to execute a so-called idling operation, which is a heating operation of heating the heating belt 1 to the preset temperature while rotating the heating belt 1 with the pressure member Fp separated from the heating member Fh. Further, to move the rotary frame 41 from the idling position to the fixing position, the movement controller C1C of the first embodiment example moves the rotary frame 41 by rotating the cam 46 in the rotation direction set by the rotation direction setting unit C1B.

### Functions of Fixing Device

In the image forming apparatus U of the first embodiment example including the above-described configuration, the recording sheet S is transported to the fixing device F with the toner image transferred to the recording sheet S in the second transfer area Q4 not fixed on the recording sheet S. In the fixing device F, the recording sheet S is pressed and heated while being nipped by the heating belt 1 and the pressure belt 31 and by the first heating roller 2 and the pressure roller 32. When the recording sheet S passes the fixing device F, therefore, the unfixed toner image is fixed on the recording sheet S with heat and pressure.

The fixing device F of the first embodiment example has the sliding pad 7 disposed downstream of the first heating roller 2, and thus the width along the transport direction of the fixing area Q5 is greater than that in a configuration not having the sliding pad 7. The heat amount supplied to the recording sheet S passing the fixing area Q5 is therefore greater than that in the case with the narrow width of the fixing area Q5, thereby reducing fixing failures.

Further, in the fixing device F of the first embodiment example, the pressure member Fp moves to the fixing position in the fixing operation, and the moves to the idling position in the idling operation. The temperature of the heating belt 1 is lower than the fixing temperature immediately after power-on or after recovery from a power save state, that is, a so-called sleep mode. If an attempt is made to increase the temperature of the heating belt 1 in this state with the pressure member Fp in contact with the heating belt 1, it takes time to increase the temperature of the heating belt 1 owing to heat transfer to the pressure member Fp. By contrast, in the first embodiment example, the heating belt 1 is increased in temperature with the pressure member Fp moved to the idling position. It is therefore possible to increase the temperature of the heating belt 1 to the fixing temperature in a shorter time than in the case of increasing the temperature of the heating belt 1 in contact with the pressure member Fp.

In the fixing device F of the first embodiment example, when the pressure member Fp moves from the idling position to the fixing position, the rotation direction of the cam 46 is set in accordance with the temperature T1 of the pressure roller 32. If the temperature T1 of the pressure roller 32 is low, therefore, the low-temperature contact surface 53 is used to move the rotary frame 41 from the idling position to the fixing position. Further, if the temperature T1 of the pressure roller 32 is high, the high-temperature contact surface 54 is used to move the rotary frame 41 from the idling position to the fixing position.

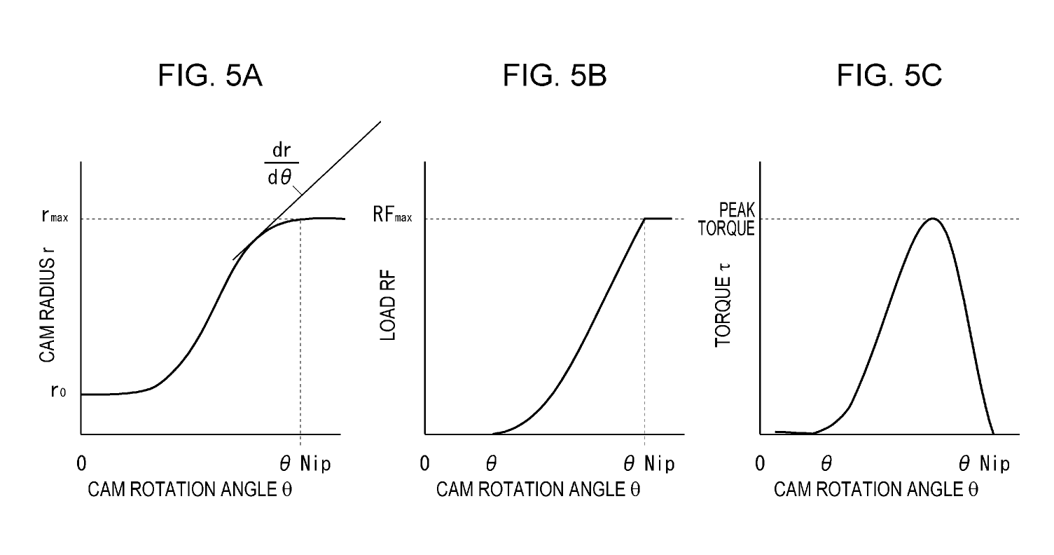

FIGS. 5A to 5C illustrate the shape of the contact member, the fixing pressure, and load torque on a drive source at low temperature. FIG. 5A is a graph with the horizontal axis representing the rotational position and the vertical axis representing the radius. FIG. 5B is a graph with the horizontal axis representing the rotational position and the vertical axis representing the load. FIG. 5C is a graph with the horizontal axis representing the rotational position and the vertical axis representing the torque.

A discussion will now be made of the load on the motor M1 that moves the rotary frame 41, that is, the driving force or so-called torque necessary for moving the rotary frame 41. It is known that, in the profile of the low-temperature contact surface 53 in FIG. 5A, the load torque acting during the rotation of the cam 46 is substantially proportional to the amount of change in radius per angle, that is, (dr/dθ). Further, in FIG. 5B, the springs 44 elastically deform with the approach of the pressure roller 32 to the first heating roller 2, and reaction force RF acts owing to the elastic force of the springs 44. The load torque acting to rotate the cam 46 is also proportional to the reaction force RF. Therefore, the load torque is proportional to RF×(dr/dθ). Accordingly, the rotational load, that is, load torque of the motor M1 has a profile as illustrated in FIG. 5C.

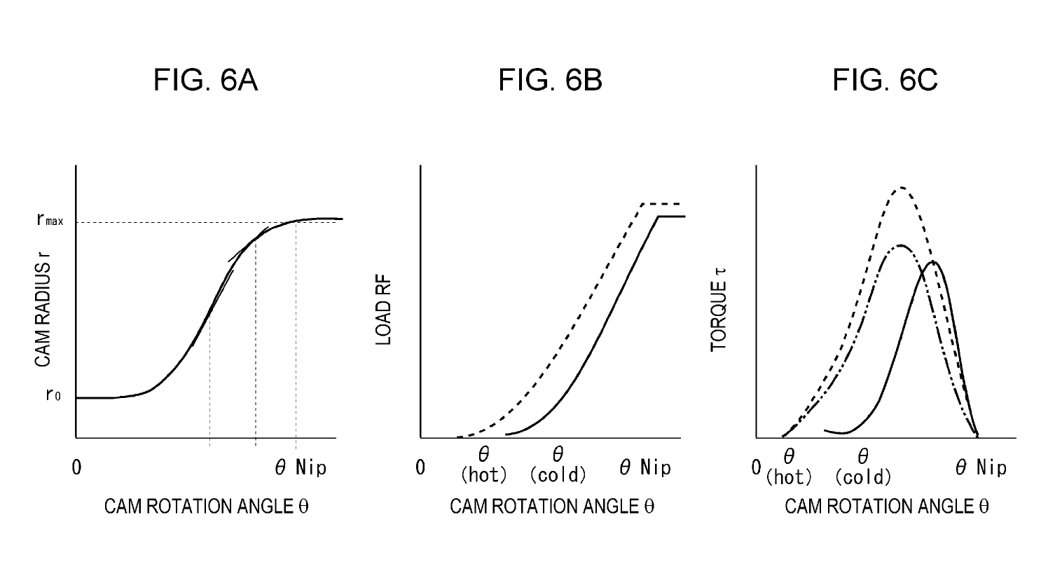

FIGS. 6A to 6C illustrate the shape of the contact member, the fixing pressure, and the load torque on the drive source at high temperature. FIG. 6A is a graph with the horizontal axis representing the rotational position and the vertical axis representing the radius. FIG. 6B is a graph with the horizontal axis representing the rotational position and the vertical axis representing the load. FIG. 6C is a graph with the horizontal axis representing the rotational position and the vertical axis representing the torque.

Herein, the pressure roller 32 in a high-temperature state thermally expands and is increased in radius. Therefore, although the profile of the cam 46 illustrated in FIG. 6A is unchanged, the time of action of the reaction force RF during the approach of the pressure roller 32 to the first heating roller 2 is advanced, and the maximum value of the reaction force RF is increased, as illustrated in FIG. 6B. As indicated by a broken line in FIG. 6C, therefore, the load torque of the motor M1 has a greater maximum value and maximized earlier than that with the profile at low temperature indicated by a solid line in FIG. 6C and illustrated in FIG. 5C. In a configuration formed only with a contact surface having a specific profile, therefore, the motor M1 may lack torque when the pressure roller 32 is at high temperature. With the lack of torque of the motor M1, the pressure member Fp fails to be moved to the fixing position, causing issues of paper jam and fixing failure. If a stepping motor or a pulse motor is used as the motor M1, there arises another issue of step-out of the motor M1 due to the lack of torque.

By contrast, in the first embodiment example, the cam 46 is formed with the low-temperature contact surface 53 and the high-temperature contact surface 54, which are configured to be selectable in accordance with the forward or reverse rotation of the motor M1. That is, the control of the motor M1 is changed depending on whether the pressure roller 32 is at high or low temperature.

Further, on the high-temperature contact surface 54, which is selected when the pressure roller 32 is at high temperature, the middle phase position 54b at which the amount of change in radius (dr/dθ) is reduced is advanced to respond to the advancement of the time at which the load torque is maximized, as compared with the corresponding position on the low-temperature contact surface 53. As indicated by a dashed double-dotted line in FIG. 6C, therefore, the amount of change in radius (dr/dθ) is reduced at a position on the broken line in FIG. 6C at which the torque is maximized, and the load torque RF×(dr/dθ) is less than that indicated by the solid line in FIG. 6C.

In the fixing device F of the first embodiment example, therefore, it is easier to move the pressure member Fp to the fixing position even in a high-temperature state than in a case in which the same contact and separation control is performed regardless of the temperature of the fixing device. That is, the occurrence of a situation is reduced in which the pressure member Fp fails to be moved to the fixing position owing to the lack of torque of the motor M1.

### Second Embodiment Example

A second embodiment example of the invention will now be described. In the description of the second embodiment example, components corresponding to the components of the foregoing first embodiment example will be assigned with the same signs, and detailed description thereof will be omitted.

The present embodiment example is different from the foregoing first embodiment example in the following aspects, but is configured similarly to the first embodiment example in the other aspects.

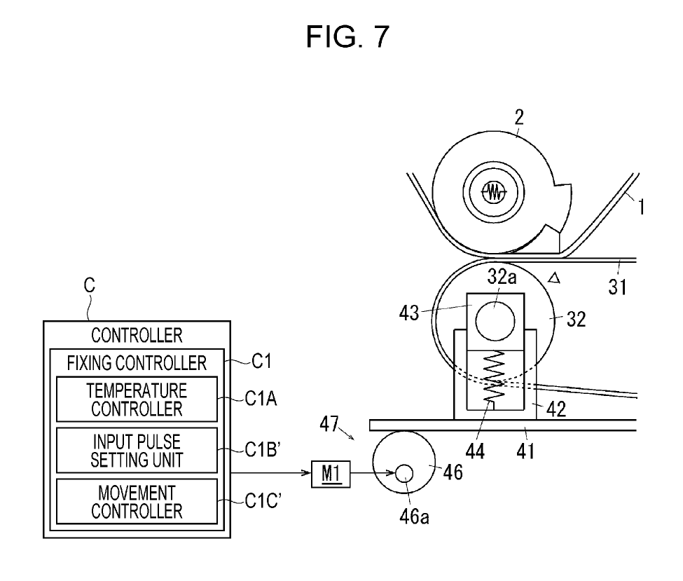

FIG. 7 is a diagram illustrating a fixing device of the second embodiment example of the invention and corresponding to FIG. 3A of the first embodiment example.

In FIG. 7, the fixing controller C1 of the second embodiment example includes an input pulse setting unit C1B′ as an example of an input setting unit in place of the rotation direction setting unit C1B of the first embodiment example, and includes a movement controller C1C′ different from the movement controller C1C of the first embodiment example.

In the second embodiment example, a stepping motor that rotates by a preset rotation angle at each input of a pulse as an example of an input signal is used as the motor M1. The second embodiment example is different from the first embodiment example in that the motor M1 only performs driving for the forward rotation.

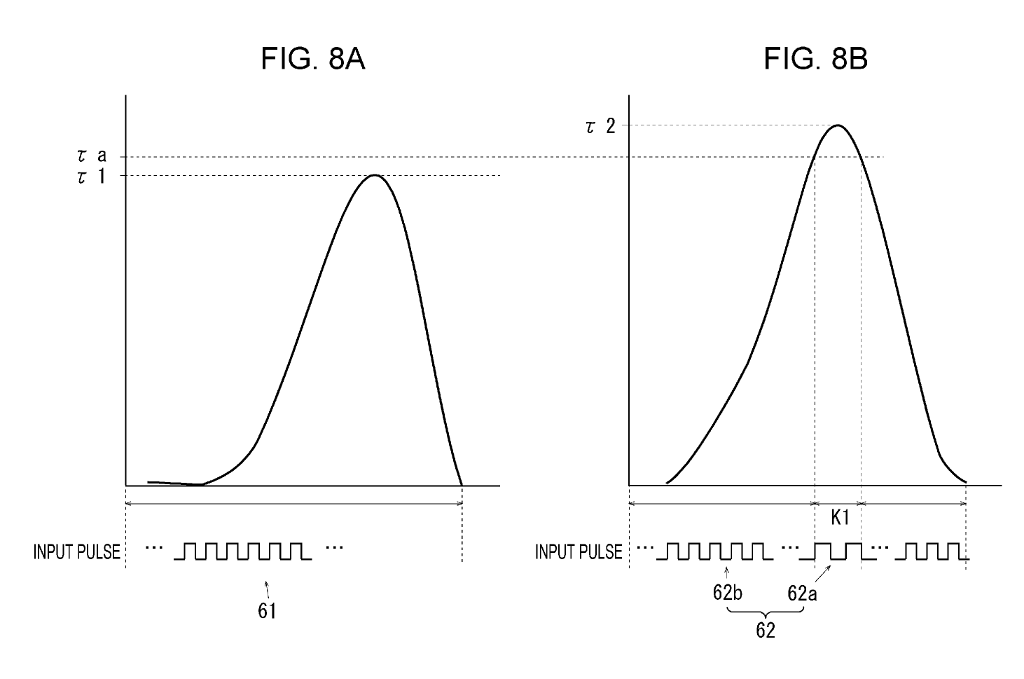

FIGS. 8A and 8B are diagrams illustrating the input signal of the second embodiment example. FIG. 8A is a diagram illustrating the input signal at low temperature. FIG. 8B is a diagram illustrating the input signal at high temperature.

If the detected temperature T1 of the temperature sensor SN is lower than the determination temperature Ta, the input pulse setting unit C1B′ of the second embodiment example selects a low-temperature input pulse 61 with a preset pulse interval as an example of input at low temperature, as illustrated in FIG. 8A. As the low-temperature input pulse 61, an input pulse is set which has previously been confirmed by an experiment or the like to be capable of driving the cam 46 without causing the step-out of the motor M1 even with maximum torque T1 at low temperature. Further, if the detected temperature T1 of the temperature sensor SN is equal to or higher than the determination temperature Ta, the input pulse setting unit C1B′ selects a high-temperature input pulse 62 as an example of input at high temperature, as illustrated in FIG. 8B.

In the second embodiment example, determination torque Ta as a value at which the motor M1 may step out is previously identified by an experiment or the like. Further, a period K1, in which the torque of the motor M1 equals or exceeds the determination torque τa at high temperature, and maximum torque τ2 are previously measured by an experiment or the like. Then, a pulse not causing the step-out of the motor M1 even with the maximum torque τ2 is selected as a pulse 62a for the period K1, in which the torque of the motor M1 equals or exceeds the determination torque τa. In the second embodiment example, the pulse 62a for the period K1, in which the torque of the motor M1 equals or exceeds the determination torque τa, is set to a pulse with a wider pulse width than that of a pulse 62b for a period in which the torque of the motor M1 is less than the determination torque τa. In the second embodiment example, therefore, an input for increasing the driving force of the motor M1 is selected in synchronization with the period K1, in which the torque corresponding to the rotational load increases to equal or exceed the determination torque τa.

In the second embodiment example, the pulse 62b for the period in which the torque of the motor M1 is less than the determination torque τa is set to be the same as the low-temperature input pulse 61, for example. Further, each of the determination torque τa, the period K1, and so forth may previously be set to the actual value thereof added with an allowance or a so-called margin.

The input pulse setting unit C1B′ of the second embodiment example therefore selects the preset low-temperature input pulse 61 as the input to be used at low temperature, and selects the preset high-temperature input pulse 62 as the input to be used at high temperature.

To move the rotary frame 41 from the idling position to the fixing position, the movement controller C1C′ of the second embodiment example inputs the input pulse 61 or 62 set by the input pulse setting unit C1B′ to the motor M1, to thereby move the rotary frame 41.

### Description of Controller in Second Embodiment Example

In the fixing device F of the second embodiment example having the above-described configuration, the control is changed in accordance with the temperature of the pressure member Fp, thereby preventing the step-out of the motor M1 even at high temperature. In the fixing device F of the second embodiment example, therefore, failures to move the pressure member Fp during the movement thereof to the fixing position are reduced as compared with in existing techniques, similarly as in the fixing device F of the first embodiment example. Accordingly, it is easier to move the pressure member Fp to the fixing position.

### Modified Examples

Although a detailed description has been made of embodiment examples of the invention, the invention is not limited to the foregoing embodiment examples, and various modifications are possible within the gist of the invention described in the claims. Modified examples (H01) to (H013) of the invention will be described below as examples.

(H01) Although the image forming apparatus U has been described as an example in the foregoing embodiment examples, the invention is not limited thereto, and is applicable to a printer, a facsimile machine, or a multifunction machine having plural functions of these. Further, the invention is not limited to a multicolor image forming apparatus, and is also applicable to a monochromatic image forming apparatus.
(H02) Although it is desirable to provide the sliding pad 7 in the foregoing embodiment examples, a configuration not provided with the sliding pad 7 is also possible.
(H03) Although the configuration of the pressure member Fp using the pressure belt 31 as an example of the endless band-shaped rotary body and the rollers 32, 33, and 34 as examples of the support member has been described as an example of the pressure member in the foregoing embodiment examples, the invention is not limited thereto. For example, a configuration is also possible which uses, in place of the pressure member Fp, a roll-shaped pressure roller not including a belt or a pressure member having any shape in accordance with the design or specifications.
(H04) Although the configuration having the pressure belt 31 stretched with tension by the three rollers 32, 33, and 34 as examples of the support member has been described as an example in the foregoing embodiment examples, the invention is not limited thereto. For example, a configuration is also possible which has the pressure belt 31 stretched with tension by two rollers or four or more rollers.
(H05) Although the configuration that causes the pressure member Fp to approach and separate from the heating member Fh has been described as an example in the foregoing embodiment examples, the invention is not limited thereto. For example, a configuration is also possible which causes the heating member Fh to approach and separate from the pressure member Fp, and the heating member Fh and the pressure member Fp may both be movably configured.
(H06) Although the configuration of the cooling device 36 including the heatsink 38 and the cooling fans 39 has been described as an example of the cooling member in the foregoing embodiment examples, the invention is not limited thereto. For example, a configuration is also possible which uses a pair of roll-shaped cooling rollers in place of the heatsink 38. Further, if the performance of cooling the recording sheet S is allowed to be low or is unnecessary, one of the heatsink 38 and the cooling fans 39 or the entire cooling member may be omitted from the configuration.
(H07) Although it is desirable to completely separate the pressure belt 31 from the heating belt 1 at the idling position in the foregoing embodiment examples, the invention is not limited thereto. For example, the pressure belt 31 may be kept in contact with the heating belt 1 with contact pressure lower than the contact pressure at the fixing position.
(H08) Although the configuration in which the pressure belt 31 is driven to rotate with the rotation of the heating belt 1 has been described as an example in the foregoing embodiment examples, the invention is not limited thereto. For example, a configuration is also possible in which the heating belt 1 is driven to rotate with the rotation of the pressure belt 31, or which includes driving members for rotating the belts 1 and 31 to rotate the belts 1 and 31 independently.
(H09) In the foregoing embodiment examples, the configuration having the heating member Fh and the pressure member Fp facing each other may be replaced by a configuration having a pair of heating members Fh symmetrically disposed to face each other.
(H010) The foregoing first and second embodiment examples may be combined to provide a configuration that changes both the rotation direction of the cam 46 and the input pulse in accordance with the temperature.
(H011) Although the configuration that changes the input pulse based on whether the detected temperature T1 of the temperature sensor SN is at least the determination temperature Ta or not has been described as an example in the foregoing second embodiment example, the determination of the temperature is not limited to the one at two levels of high and low, and may be determination at three or more levels. If the determination is made at three or more levels, three or more types of input pulses may be prepared to adjust to such a modification.
(H012) Although the configuration that inputs similar pulses as the low-temperature input pulse 61 throughout the entire period has been described as an example in the foregoing second embodiment example, the invention is not limited thereto. For example, the configuration may be modified such that, even in the low-temperature input pulse 61, if the maximum torque τ1 exceeds a preset torque determination value τb (<τ1), a pulse for increasing the driving force is input during the period in which the maximum torque τ1 exceeds the torque determination value τb, similarly as in the high-temperature input pulse 62.
(H013) Although the use of the pulse with a wide pulse width to increase the driving force has been described as an example in the foregoing embodiment examples, the invention is not limited thereto. For example, the current value to be supplied to the motor may be increased to increase the driving force.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a pair of fixing members disposed to face each other in a fixing area in which an unfixed image is fixed;
a movable member that movably supports at least one of the fixing members between a first position at which one of the fixing members and an other one of the fixing members come into contact with each other with preset fixing pressure and a second position at which the one of the fixing members and the other one of the fixing members are relatively moved in a direction of separating farther from each other than at the first position;
a driving device that includes a contact member and a drive source and moves the movable member between the first position and the second position, the contact member supported to be rotatable around a rotation center and contacting the movable member, and the drive source driving the contact member; and
a controller that controls the driving device, and if a temperature of the one of the fixing members is equal to or higher than a preset temperature when the driving device moves the movable member from the second position to the first position, changes the control of the driving device to make driving force constantly exceed a rotational load of the driving device in accordance with advancement of a time of increase in the rotational load as compared with when the temperature of the one of the fixing members is lower than the preset temperature.

2. The fixing device according to claim 1, wherein the drive source drives the contact member to perform forward or reverse rotation,
wherein the contact member includes a surface contacting the movable member, the surface including a first contact position of a surface contacting the movable member moved to the first position, a second contact position of a surface contacting the movable member moved to the second position, a first contact surface formed of a surface between the second contact position and the first contact position along a forward rotation direction, and a second contact surface formed of a surface between the second contact position and the first contact position along a reverse rotation direction, and an area with a small amount of change in radius of the contact member relative to a rotation direction is set to be closer to the second contact position on the second contact surface than on the first contact surface, and
wherein, if the temperature of the one of the fixing members is lower than the preset temperature, the controller causes the contact member to perform the forward rotation to bring the first contact surface into contact with the movable member and move the movable member from the second position to the first position, and if the temperature of the one of the fixing members is equal to or higher than the preset temperature, the controller causes the contact member to perform the reverse rotation to bring the second contact surface into contact with the movable member and move the movable member from the second position to the first position.

3. The fixing device according to claim 1, wherein the controller controls input to the drive source to control the driving force of the drive source, and if the temperature of the one of the fixing members is equal to or higher than the preset temperature, the controller performs input for increasing the driving force in synchronization with the time of the increase in the rotational load during a period of the movement from the second position to the first position.

4. An image forming apparatus comprising:
an image carrier that carries an image on a surface thereof;
a transfer device that transfers the image onto a medium from the image carrier; and
the fixing device according to claim 1, which fixes the image transferred to and unfixed on the medium.

5. A fixing method comprising
disposing a pair of fixing members to face each other in a fixing area in which an unfixed image is fixed;
movably supporting, with a movable member, at least one of the fixing members between a first position at which one of the fixing members and an other one of the fixing members come into contact with each other with preset fixing pressure and a second position at which the one of the fixing members and the other one of the fixing members are relatively moved in a direction of separating farther from each other than at the first position;
moving the movable member between the first position and the second position with a driving device including a contact member supported to be rotatable around a rotation center and contacting the movable member and a drive source for driving the contact member; and
controlling the driving device, and if a temperature of the one of the fixing members is equal to or higher than a preset temperature when moving the movable member from the second position to the first position, changing the control of the driving device to make driving force constantly exceed a rotational load of the driving device in accordance with advancement of a time of increase in the rotational load as compared with when the temperature of the one of the fixing members is lower than the preset temperature.
